(19) United States
(12) Patent Application Publication
(10) Pub. No.: US 2026/0342827 A1
(43) Pub. Date: Oct. 29, 2026

(54) IDENTIFICATION OF AN ARTIFICIAL INTELLIGENCE (AI) MASKED ATTACK

(71) Applicant: Micro Focus LLC, Wilmington, DE (US)

(72) Inventors: Douglas Max Grover, Rigby, ID (US); Michael F. Angelo, Houston, TX (US)

(73) Assignee: Micro Focus LLC, Wilmington, DE (US)

(21) Appl. No.: 19/190,563

(22) Filed: Apr. 25, 2025

(51) Int. Cl. H04L 9/40; H04L 41/16

(52) U.S. Cl. CPC H04L 63/1425; H04L 41/16; H04L 63/1416

(57) ABSTRACT

The present disclosure is directed to systems, devices, and methods to identify an Artificial Intelligence (AI) masked attack on a network. Identifying the AI masked attack may comprise using a machine learning process to detect activity that varies from normal traffic, including comparing values for one or more parameters to stored thresholds. Identifying the AI masked attack may also comprise detecting a change in one or more parameters over time, including monitoring a series of thresholds over time to detect a variance.

### FIELD

The disclosure relates generally to detecting a masked attack, and particularly to identifying an artificial intelligence (AI) masked attack.

### BACKGROUND

In cybersecurity, a “masked attack” (also known as a masquerading attack) involves attackers disguising their malicious activities or artifacts to appear legitimate, making the attackers difficult to detect and manage. This can include mimicking legitimate traffic patterns or impersonating trusted entities.

Trying to manually monitor activity in large computer networks in real-time is impossible. With the proliferation of so many different types of attacks and variances in each of these types of attacks, it is a never-ending threat to network/corporate security.

### SUMMARY

These and other needs are addressed by the various embodiments and configurations of the present disclosure. The present disclosure can provide a number of advantages depending on the particular configuration. These and other advantages will be apparent from the disclosure contained herein.

Attackers may use AI to monitor a network to determine what “normal” traffic looks like in order to mimic or slowly change what the network considers “normal” traffic. The attackers may then mimic “normal” traffic with their attacks. Attackers may monitor network parameters such as, packet size, packet spacing, bandwidth, volume, direction, frequency, intensity (ratio of volume to capacity), applications a specific device/user accesses, user work hours, which devices a specific device communicates with, password attempts, etc. When the attacker knows the values of for these parameters, the attack can mimic “normal” traffic or slowly change what the network considers “normal” traffic.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for identifying an artificial intelligence (AI) masked attack.

FIG. 2 is an example database that is used for identifying an AI masked attack.

FIG. 3 is a flow diagram of a process for identifying an AI masked attack

FIG. 4 is a flow diagram of a process for identifying an AI masked attack.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Masquerading or masked attacks are a type of cyberattack where threat actors attempt to hide their malicious actions by making them appear legitimate. Attackers may mimic legitimate traffic to blend and disguise their malicious traffic with normal network activity, making it difficult for security systems to identify and block them. Attackers may impersonate legitimate users, services, or systems to gain unauthorized access or perform malicious actions. Masquerading attacks can also involve phishing techniques, where attackers use deceptive emails or messages to trick users into revealing sensitive information or clicking on malicious links. Masquerading attacks are difficult to detect because they are designed to blend in with normal activity, making it harder for security systems to identify and block them. The difficulty in detecting these attacks can lead to delays in response, allowing attackers to exploit vulnerabilities and cause more damage. By impersonating trusted entities, attackers can exploit trust and gain access to sensitive information or systems that they would otherwise not be able to access.

Nefarious parties are now employing malicious artificial intelligence (AI) algorithms coupled with malware to avoid detection of malicious activity. For example, an AI algorithm may be used to monitor network traffic to identify normal looking traffic patterns, and then try to mask an attack by generating traffic, that mimics the normal looking traffic, coupled with an attack. Additionally, an AI algorithm can monitor network traffic to identify activity of an individual user on the network and learn what applications, servers, devices, etc. are accessible to the individual user to determine better ways to attack the network, applications, servers, devices, etc. Additionally, an AI algorithm may identify normal traffic and slowly change what is identified as normal traffic. For example, the malicious AI algorithm identifies User A's normal working hours to be 9 am-5 pm local time. Over the course of a few months, the AI algorithm may generate activity that changes User A's normal working hours from 9 am-5 pm to 7 am-7 am. Since the change occurs slowly over time, it would not be detected as unusual activity.

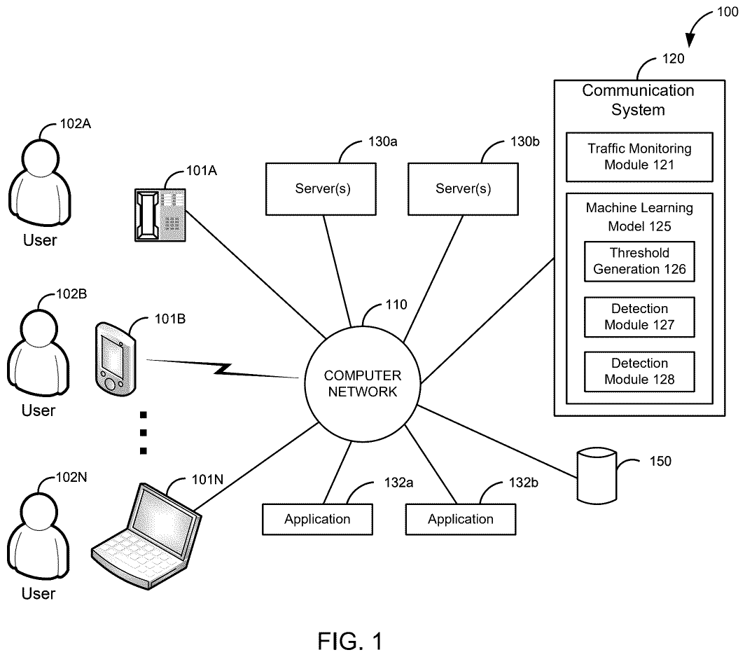

FIG. 1 is a block diagram of a first illustrative system 100 for identifying an AI masked attack on a computer network 110. The first illustrative system 100 comprises communication devices 101A-101N, the computer network 110, a communication system 120, servers 130a-b, applications 132a-b, and database 150. In addition, users 102A-102N are shown for convenience. The users 102A-102N are users of the communication devices 101A-101N.

The communication system 120 includes a traffic monitoring module 121 and a machine learning model 125. The machine learning model 125 may include a threshold generation module 126, a detection module 127, and a detection module 128. The traffic monitoring module 121 may monitor traffic on the computer network 110. For example, the traffic monitoring module 121 may continuously monitor traffic on the computer network 110. In other examples, the traffic monitoring module 121 may periodically monitor traffic on the computer network 110. The machine learning model 125 may be a supervised or unsupervised machine learning model. For example, historical traffic on the network (e.g. the computer network 110) may be used to train the machine learning model 125.

The machine learning model 125 may be trained using historical network data for the network or a similar network. The machine learning model 125 is trained so that it may subsequently identify a variance in normal traffic over time to identify a masked AI attack. This input/output data is recorded into the machine learning model 125, such as by using tables or other data formats accepted by the model. The machine learning model 125 may be a hybrid of supervised and unsupervised learning models, e.g., a semi-supervised learning model, to allow the model to infer output by itself. Alternatively, the machine learning model 125 may be supervised or unsupervised with appropriate configurations. By using a hybrid, semi-supervised, learning model, input may be included without defining the respective output, thus allowing the model to infer by itself.

In this context, the purpose of the machine learning model 125 is to create and execute a model (e.g., function) that derives an output (e.g., detection of a variance) from an input (input data). The model is created during a training phase by using the traffic data provided to it. In a classic supervised machine learning algorithm there are two separated data sets, one for input and another one for output, that together provide an input/output pair. The machine learning model 125 is an algorithm, defined by executable instructions either alone and/or in combination with hardware blocks, that, during a training phase, captures, and learns from, the data to identify masked AI attacks. After the machine learning model 125 is sufficiently trained to become a trained model, then the model is used to monitor traffic on a network.

The database 150 may store the thresholds generated by the threshold generation module 126. For example, multiple thresholds may be stored for each parameter. The thresholds may be generated and stored periodically. The database 150 may store a series (or history) of thresholds for each parameter.

The communication devices 101A-101N can be or may include any user device that can communicate on the computer network 110, such as a Personal Computer (PC), a telephone, a video system, a cellular telephone, a Personal Digital Assistant (PDA), a tablet device, a notebook device, a smartphone, a smart watch, and/or the like. As shown in FIG. 1, any number of communication devices 101A-101N may be connected to the computer network 110.

The computer network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The computer network 110 can use a variety of electronic protocols, such as Ethernet, Internet Protocol (IP), Hyper Text Transfer Protocol (HTTP), Web Real-Time Protocol (Web RTC), and/or the like. Thus, the computer network 110 is an electronic communication network configured to carry messages via packets and/or circuit switched communications.

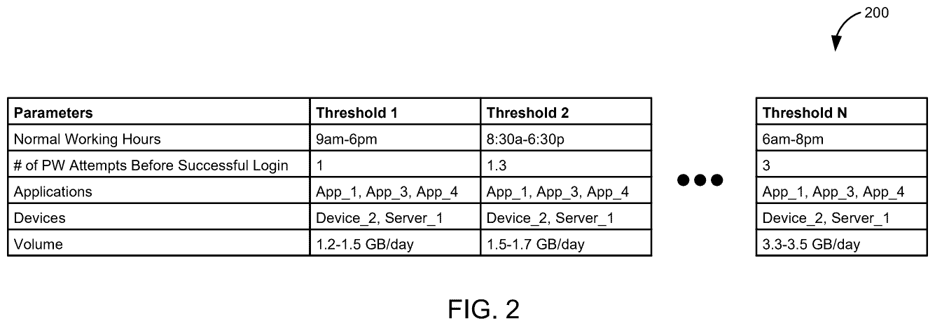

FIG. 2 is an example database 200 for identifying an AI masked attack on a computer network (e.g., the computer network 110). The database 200 is for illustrative purposes only, the database may contain more parameters not shown. The values of the parameters are for illustrative purposes only. For example, the threshold values shown in FIG. 2 may be generated using machine learning model 125 and threshold generation module 126. For example, thresholds for each parameter may be sampled over ten periods (not shown). The variance (e.g., increase or decrease) between each sampled period may be small (e.g., below a threshold to trigger an alert), but the overall variance may be enough to indicate an attack. For example, the volume between each sample may have a variance of <1%, which over ten samples equates to a variance of 10%. A change in traffic volume of 10% would trigger an alert, but a change of <1% may not. So the attacker slowly changes the “normal” or expected traffic volume until after three months, the network is now expecting 10% more traffic volume. In other words, the present disclosure monitors a series of thresholds and detects a variance over time.

The database 200 includes columns, “Parameters,” that lists the various parameters being monitored. For example, the parameters being monitored may include normal working hours, number of password attempts before a successful login, applications used, devices communicated with, the average volume of data transferred (e.g., per day, per hour, per month, etc.). The database 200 also includes columns for different thresholds (e.g., Thresholds 1-N) that are calculated over a period of time. For example, the system monitors the values over time and periodically calculates an average value. The system may keep track of each threshold that is calculated in order to detect a variance over time. The database 200 may correspond to a User A, with other databases for other users.

As illustrated in FIG. 2, the threshold for normal working hours for User A may start at 9 am-6 pm, and changes to 8:30 am-6:30 pm, and again to 6 am-8 pm each time the threshold is measured/generated. The variance may be associated with User A's actual behavior, or may be caused by an attacker's AI, in order to obscure malicious behavior. The variance between threshold 1 and threshold 2 is small and may attributable to a normal variance. However, the variance between threshold 1 and threshold N is quite large and most likely indicates an attack. An attacker using AI slowly changes the “normal/expected” parameters values, which over time can lead to a large variance. The variance would not be detected when comparing threshold N to a previous threshold, but is detected when compared to a series of previous thresholds.

User A's number of passwords attempts before a successful login also changes from 1 to 1.3 to 1.7. The increase in the threshold may indicate increased wrong password attempts associated with an attacker trying to guess User A's password.

User A's volume also increases from 1.2-15 GB/day to 1.5-1.7 GB/day to 1.7-2.1 GB/day. This may indicate an attacker is masking an attack as normal traffic. For example, the attacker may access the devices (e.g., Device_2 and Server_1) that User A normally accesses, which increases traffic volume, without accessing different devices that User A does not have a history of accessing, which would trigger unusual activity.

In embodiments, the detection module 127 may compare current values for one or more of the parameters with the stored thresholds to detect a variance. In embodiments the detection module 128 may compare the stored thresholds to detect a variance.

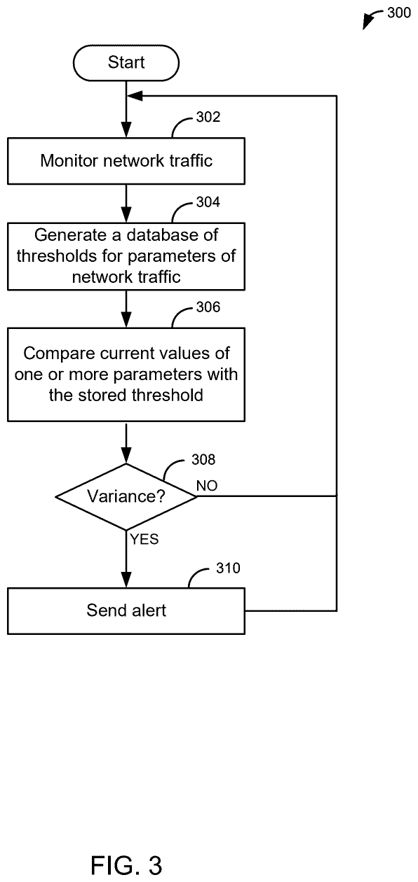

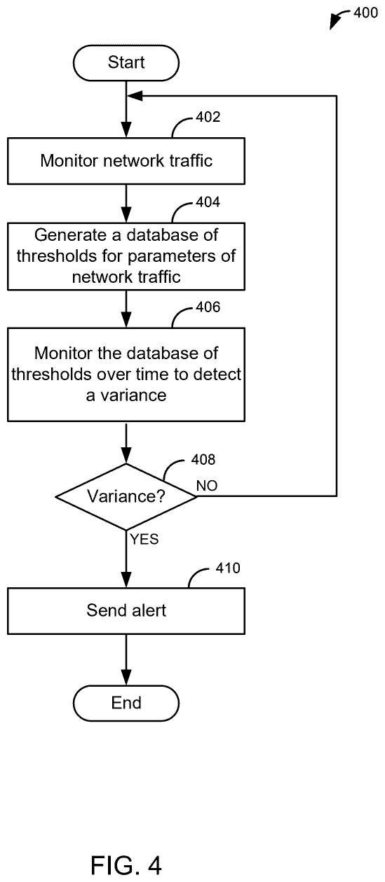

FIG. 3 is a flow diagram of a process 300 for using AI to identify an AI masked attack. Illustratively, the communication devices 101A-101N, the communication system 120, the machine learning model 125, the threshold generation module 126, the detection modules 127-128 are stored-program-controlled entities, such as a computer or microprocessor, which performs the method of FIGS. 3-4 and the processes described herein by executing program instructions stored in a computer readable storage medium, such as a memory (i.e., a computer memory, a hard disk, and/or the like). Although the methods described in FIGS. 3-4 are shown in a specific order, one of skill in the art would recognize that the steps in FIGS. 3-4 may be implemented in different orders and/or be implemented in a multi-threaded environment. Moreover, various steps may be omitted or added based on implementation.

The process 300 starts. The machine learning model 125 monitors network traffic, in step 302. In embodiments, the traffic monitoring module 121 may be part of the machine learning model 125, or separate from the machine learning model 125. The traffic monitoring module 121 may transfer telemetry data to the machine learning model 125.

The trained machine learning model 125, in step 304, generates a database (e.g., the database 200) of thresholds for parameters of network traffic. For example, the threshold generation module 126 may periodically calculate a threshold value for each parameter based on the monitored network traffic. In embodiments, the threshold value may comprise an average value for the parameter based on the monitored network traffic.

The trained machine learning model 125, in step 306 compares current values for one or more parameters with an associated threshold. For example, the traffic monitoring module 121 may transfer current telemetry data for the computer network 110 to the machine learning model 125. In step 308, the machine learning model 125 determines if there is a variance between the current value and the stored threshold. If there is no variance or the variance does not exceed at threshold (No), the process 300 continues with step 302. If there is a variable of the variance exceeds a threshold (Yes), an alert is sent in step 310. Additionally, the machine learning model 125 may compare activity associated with the detected variance with a database storing activity associated with known attacks to identify a type of attack associated with the variance. The process 300 continuously monitors the network for unusual activity.

FIG. 4 is a flow diagram of a process 400 for using AI to identify an AI masked attack. The process 400 starts. The machine learning model 125 monitors network traffic, in step 402. In embodiments, the traffic monitoring module 121 may be part of the machine learning model 125, or separate from the machine learning model 125. The traffic monitoring module 121 may transfer telemetry data to the machine learning model 125.

The trained machine learning model 125, in step 404, generates a database (e.g., the database 200) of thresholds for parameters of network traffic. For example, the threshold generation module 126 may periodically calculate a threshold value for each parameter based on the monitored network traffic. In embodiments, the threshold value may comprise an average value for the parameter based on the monitored network traffic.

The trained machine learning model 125, in step 406 monitors the values in the database of thresholds over time to detect a variance. In step 408, the machine learning model 125 determines if there is a variance in the values in the database of thresholds over time. If there is no variance or the variance does not exceed at threshold (No), the process 400 continues with step 402. If there is a variable of the variance exceeds a threshold (Yes), an alert is sent in step 410. Additionally, the machine learning model 125 may compare activity associated with the detected variance with a database storing activity associated with known attacks to identify a type of attack associated with the variance. The process 400 continuously monitors the threshold database for unusual activity.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
monitor, using a machine learning process, traffic on a network;
generate, using the machine learning process, a database of thresholds for one or more parameters for the traffic on the network, wherein the database stores a series of thresholds for each parameter;
compare, using the machine learning process, a current value for each parameter with the series of thresholds for each parameter in the database to determine if there is a variance for each parameter and a stored threshold; and
in response to the variance for a parameter exceeding a threshold, trigger an alert.

2. The system of claim 1, further comprising instructions that, when executed by the microprocessor, cause the microprocessor to:
gather first values for the one or more parameters during a first time period to generate a first threshold for each of the one or more parameters; and
gather second values for the one or more parameters during a second time period to generate a second threshold for each of the one or more parameters.

3. The system of claim 1, further comprising instructions that, when executed by the microprocessor, cause the microprocessor to:
monitor, using the machine learning process, the series of thresholds for each parameter in the database over a period of time to determine if there is a variance in each parameter over the period of time.

4. The system of claim 1, further comprising instructions that, when executed by the microprocessor, cause the microprocessor to:
if the variance is detected, compare activity associated with the variance to a database of activity associated with known attacks to identify a type of attack associated with the variance.

5. The system of claim 1, wherein the traffic on the network comprises which other network devices that communicate with a first network device.

6. The system of claim 1, wherein the traffic on the network comprises which applications a network device uses.

7. The system of claim 1, wherein the one or more parameters comprise working hours of a user.

8. The system of claim 1, wherein the one or more parameters comprise a number of failed password attempts.

9. A method comprising:
monitoring, using a machine learning process, traffic on a network;
generating, using the machine learning process, a database of thresholds for one or more parameters for the traffic on the network, wherein the database stores a series of thresholds for each parameter;
comparing, using the machine learning process, a current value for each parameter with the series of thresholds for each parameter in the database to determine if there is a variance for each parameter and a stored threshold; and
in response to the variance for a parameter exceeding a threshold, triggering an alert.

10. The method of claim 9, further comprising:
gathering first values for the one or more parameters during a first time period to generate a first threshold for each of the one or more parameters; and
gathering second values for the one or more parameters during a second time period to generate a second threshold for each of the one or more parameters.

11. The method of claim 9, further comprising:
monitoring, using the machine learning process, the series of thresholds for each parameter in the database over a period of time to determine if there is a variance in each parameter over the period of time.

12. The method of claim 9, further comprising:
if the variance is detected, compare activity associated with the variance to a database of activity associated with known attacks to identify a type of attack associated with the variance.

13. The method of claim 9, wherein the traffic on the network comprises which network devices that communicate with a first network device.

14. The method of claim 9, wherein the traffic on the network comprises which applications a network device uses.

15. The method of claim 9, wherein the one or more parameters comprise working hours of a user.

16. The method of claim 9, wherein the one or more parameters comprise a number of failed password attempts.

17. A non-transient computer readable medium having captured thereon instructions that cause a processor to execute a method, the method comprising instructions to:
monitor, using a machine learning process, traffic on a network;
generate, using the machine learning process, a database of thresholds for one or more parameters for the traffic on the network, wherein the database stores a series of thresholds for each parameter;
compare, using the machine learning process, a current value for each parameter with the series of thresholds for each parameter in the database to determine if there is a variance for each parameter and a stored threshold; and
in response to the variance for a parameter exceeding a threshold, trigger an alert.

18. The non-transient computer readable medium of claim 17, further comprising instructions to:
gather first values for the one or more parameters during a first time period to generate a first threshold for each of the one or more parameters; and
gather second values for the one or more parameters during a second time period to generate a second threshold for each of the one or more parameters.

19. The non-transient computer readable medium of claim 17, further comprising instructions to:
monitor, using the machine learning process, the series of thresholds for each parameter in the database over a period of time to determine if there is a variance in each parameter over the period of time.

20. The non-transient computer readable medium of claim 17, further comprising instructions to:
if the variance is detected, compare activity associated with the variance to a database of activity associated with known attacks to identify a type of attack associated with the variance.
